(19) United States
(12) Patent Application Publication
(10) Pub. No.: US 2025/0007453 A1
(43) Pub. Date: Jan. 2, 2025

(54) MEASURING SYSTEM AND METHOD COMPRISING AN ENERGY MANAGEMENT ARRANGEMENT

(71) Applicant: VEGA Grieshaber KG, Wolfach (DE)

(72) Inventors: Florian KRAEMER, Muehlenbach (DE); Stefan ALLGAIER, Oberwolfach (DE); Patrick HEIZMANN, Oberwolfach (DE)

(73) Assignee: VEGA Grieshaber KG, Wolfach (DE)

(21) Appl. No.: 18/673,029

(22) Filed: May 23, 2024

(30) Foreign Application Priority Data
May 25, 2023 (DE) 10 2023 113 818.9

(51) Int. Cl. H02S 50/10; G01D 21/02

(52) U.S. Cl. CPC H02S 50/10; G01D 21/02

(57) ABSTRACT

A measuring system which is configured to measure a filling level, a limit level and/or a pressure. The measuring system includes a measuring sensor having an operating mode, and an energy management arrangement, which has a control device and is configured to control the power supply for the measuring sensor. The control device of the energy management arrangement is coupled to the measurement sensor and is configured to activate the operating mode of the measurement sensor in an event-oriented manner and/or to generate the electrical energy for operating the measurement sensor in the operating mode and/or to supply the measurement sensor in the operating mode with the generated electrical energy. The present disclosure further relates to an energy management arrangement for a measuring system, a method by a measuring system for measuring a level, a limit level and/or a pressure and a computer-readable medium.

### CROSS-REFERENCE TO RELATED APPLICATIONS

This application claims the benefit of the filing date of German Patent Application No. 10 2023 113 818.9 filed on 25 May 2023, the entire content of which is incorporated herein by reference.

### TECHNICAL FIELD

The present disclosure relates to process measurement technology and process automation in an industrial environment. In particular, the present disclosure relates to a measuring system for measuring a filling level, a limit level and/or a pressure, an energy management arrangement for a measuring system, the use of an energy management arrangement for saving energy in a process plant, the use of a measuring system for a filling level, limit level and/or pressure measurement in a container and/or at an open measuring point of a body of water, a method using a measuring system for measuring a filling level, a limit level and/or a pressure and a computer-readable medium.

### TECHNICAL BACKGROUND

Field devices are often used in industrial environments to measure relevant measured variables in the process plant. To ensure that the sensors and the other electrical components of the field devices can remain in use reliably over a long period of time, a safe power supply system is of great importance, especially if the sensors are of different types and are distributed across several measuring points in the system.

### SUMMARY

There may be a desire to provide a field device in an installation with an improved energy harvesting or energy management system.

A first aspect of the present disclosure relates to a measuring system which is configured for measuring at least one of a level, a limit level and/or a pressure and comprises a measuring sensor having an operating mode and an energy management arrangement.

The energy management arrangement has a control device and is configured to activate the operating mode of the measuring sensor in an event-oriented manner and/or to generate the electrical energy for operating the measuring sensor in the operating mode and/or to supply the measuring sensor in the operating mode with the generated electrical energy.

The activation by means of the control device of the energy management system can be event-oriented based on the presence or detection of the light beam, for example at sunrise, a predetermined light intensity of the light beam, a predetermined angle of incidence of the light beam or a weather condition, such as heavy rainfall, in the environment. Alternatively or additionally, activation by means of the control device of the energy management system can be event-driven in the event of a location-dependent measurement, a time-dependent measurement or a position-dependent measurement, for example if the container is arranged vertically or horizontally. Alternatively or additionally, activation by means of the control device of the energy management system can be event-driven in the event of an external trigger by a further sensor, a temperature-dependent measurement or a vibration-dependent measurement.

Conventionally, a stand-alone measuring sensor can be used to save energy, which can be switched on cyclically or according to a fixed time pattern. This allows the measuring process to be triggered by the measuring sensor.

Compared to the case in which, for example, a stand-alone measuring sensor can only be operated continuously or in a fixed predetermined time pattern, and in which there may be relatively intensive energy consumption and/or a relatively large maintenance effort may be required for the regular replacement of the used batteries or accumulators, the measuring sensor of the measuring system can be activated and put into operating mode only a few times per day or per week or per year by the event-oriented activation by means of the energy management arrangement for measuring a level, limit level and/or pressure to be monitored. When the measuring sensor is not in operating mode, the energy supply can be prevented or minimized by the energy management arrangement to further reduce the unnecessary energy loss of the measuring system. As a result, a low-maintenance and energy-saving measuring system for event-oriented level, limit level and/or pressure measurement can be realized.

For example, it may be possible to set different parameters in an event-oriented manner to activate the operating mode of the measurement sensor. For example, a parameter change for the measurement by means of the measurement sensor can be carried out in the light or in the dark. For example, it may be possible for the operating mode of the measurement sensor to be activated every 15 minutes in the light and/or every 12 hours in the dark. Alternatively, the operating mode of the measurement sensor can be activated every 12 hours in the light and/or every 15 minutes in the dark.

According to an embodiment, the energy management arrangement has a solar harvesting arrangement as a first supply unit. The solar harvesting arrangement can be configured to supply the measurement sensor with electrical energy in the operating mode.

For example, Enocean technology can be used so that only small amounts of energy, which can be generated by harvesting methods, are required to send short radio signals from the measurement sensor. Energy harvesting can generally refer to the harvesting of small amounts of electrical energy from sources such as ambient temperature, light, vibrations and/or air currents.

With the solar harvesting arrangement, the energy management arrangement of the measuring system can also enable energy harvesting from the light energy so that the energy supply for operating the measuring sensor or the measuring system can be relieved.

Furthermore, the solar harvesting arrangement may massively reduce the energy consumption of the entire measuring point for the measuring sensor. In some cases, little or even no energy may be required. Alternatively, it can be provided that the measuring sensor can only carry out the measurement at the measuring point where little energy is available for operating the rechargeable battery or battery-operated measuring sensor when it is necessary. This can lead to a longer service life and lower maintenance costs, e.g., by changing the battery for the measuring system.

According to a further embodiment, the solar harvesting arrangement of the energy management arrangement comprises a light collecting unit arranged to collect and/or concentrate the light energy, an optical waveguide and a solar cell arranged to generate the electrical energy from the light energy.

The solar cell or solar module can be attached to the measurement sensor to protect it from mechanical damage or deterioration.

In addition, the optical fiber can be arranged between the light collection unit and the solar cell and can be configured to guide the light energy from the light collection unit to the solar cell. In this way, the light energy can be collected and emitted in a targeted manner in order to control the wake-up and energy generation of the measurement sensor.

The advantage of the fiber optic cable can be that there can be no interference from electromagnetic and electrical influences, which in turn can interfere with the measuring sensor.

According to a further embodiment, the light collection unit is arranged at a distance from the solar cell.

The light collection unit can be arranged at a distance or offset from the solar cell and/or the measuring sensor. The distance between the light-collecting unit and the solar cell and/or the measuring sensor can be provided individually depending on the application.

According to a further embodiment, the light collection unit has a lens.

The lens, which may be a focusing lens, may be configured to concentrate light rays, such as the sun, to increase the efficiency of collecting light energy.

According to a further embodiment, the light collection unit is designed to be movable so that the light collection unit can be flexibly aligned.

The light collection unit can be designed to be movable so that it can automatically track the sun. This means that the light energy can be directed by the movement of the light collection unit so that the maximum light energy from the light source or the sun can be efficiently collected and concentrated.

In addition, it is possible that the light collection unit, which is offset or spaced apart from the measuring sensor and/or the solar cell, can be operated completely without a power supply or with a battery or rechargeable battery. By means of the light collection unit, which is offset from the measuring sensor, the collected light can be guided through the focusing lens via the movable optical fiber to the sensor and/or to the solar cell or the solar module.

For example, the lens of the light-collecting unit can focus the light even when the incidence of light is at an angle, so that there can be significant advantages over a solar panel without a lens. Possible soiling or partial shading can also hardly have a negative effect on power generation.

According to a further embodiment, the solar harvesting arrangement of the energy management arrangement also has a connection that is configured for retrofitting the optical waveguide and/or the light collection unit to the measurement sensor.

The connection can, for example, be designed as a screw connection unit and arranged directly on the solar cell or between the solar cell and the fiber optic cable. Alternatively, the connection can be integrated into the sensor together with the solar cell. The connection can be designed in such a way as to enable or simplify the connection or attachment of the optical fiber to the solar cell. In addition, the connection can be designed in such a way that the optical waveguide can be detachably attached to the solar cell. This means that the optical waveguide can be easily retrofitted and/or replaced.

According to a further embodiment, the solar cell is arranged on the measuring sensor. Alternatively, the solar cell can be integrated into the measurement sensor.

For example, the solar cell can be arranged in direct contact with the measurement sensor or at least partially integrated into the measurement sensor. When the solar cell is arranged on the measurement sensor, the electrical energy converted by the light energy can be used directly and without significant loss to supply the measurement sensor.

According to a further embodiment, the optical waveguide is flexible and/or elongated.

The fiber optic cable can consist of a glass fiber cable, for example.

According to a further embodiment, the measuring sensor is arranged inside a container and/or at a dark measuring point.

For example, the measuring sensor can be arranged remotely from the light collection unit of the energy collection unit deep in a container or shaft or inside a container housing. The light collection unit, on the other hand, can be arranged outside the closed container for receiving and collecting the light energy and can be configured to guide or conduct the collected light energy through the optical fiber through the lid of the container to the solar cell for converting the light energy into electrical energy for supplying the measuring sensor in the operating mode.

Alternatively, the remotely arranged light collection unit can be arranged in the container together with the measuring sensor. In this case, the light-collecting unit can be arranged below a transparent container lid so that the light-collecting unit can collect the light beam or light energy through the lid.

Alternatively, the light collection unit can be housed as a solar collector in a hinged cover. This hinged cover can collect the solar energy and pass it on to the solar cell inside the measuring sensor via the optical fiber. This arrangement can have the advantage that the surface of the measurement sensor remains free for a display and/or an operating element. This means, for example, that the lens of the light collection unit can be optimally aligned.

Alternatively, the light collecting unit can be located in an open area, such as in a road or at the top of a bridge over a body of water, while the measuring sensor and/or the solar cell can be located in the dark area underground or below the bridge over a body of water or a canal in order to measure the level, the limit level and/or the pressure.

According to a further embodiment, the control device of the energy management system is configured to activate the operating mode of the measurement sensor at a predefined time interval.

In addition to the event-oriented activation of the operating mode of the measurement sensor by the energy harvesting arrangement, the regular activation of the operating mode can be carried out with the specified time interval in order to achieve a combined or mixed activation mode.

According to a further embodiment, the energy management arrangement also has a second supply unit, which is configured to supply the measuring sensor with power.

According to a further embodiment, the second supply unit of the energy management arrangement is a battery or an accumulator.

This means that the measuring system can be at least partially self-sufficient. Thanks to the energy management arrangement with the first and second supply units, the measuring system can be used over a long period of time in a process plant and even in an operating site in a potentially explosive area.

In addition, the measurement sensor of the measurement system can send the measurement data wirelessly, for example via radio communication technology. In comparison to wired communication, in which the energy required for the measurement and transmission of the measured values must be permanently in use, battery-operated sensors, for example for monitoring fill level, limit level or pressure values, may become increasingly important with the availability of more advanced, energy-saving wireless technologies. There are particular advantages for applications in the field of process automation in industrial environments such as logistics.

The term “process automation in an industrial environment” may be understood as a branch of technology that includes all measures for the operation of machines and systems without the involvement of humans. One aim of process automation is to automate the interaction of individual components of a plant in the chemical, food, pharmaceutical, petroleum, paper, cement, shipping or mining industries. A variety of sensors can be used for this purpose, which are adapted in particular to the specific requirements of the process industry, such as mechanical stability, insensitivity to contamination, extreme temperatures and extreme pressures. Measured values from these sensors are usually transmitted to a control room, where process parameters such as fill level, limit level, flow rate, pressure or density can be monitored and settings for the entire plant can be changed manually or automatically.

One area of process automation in the industrial environment is logistics automation. Distance and angle sensors are used in logistics automation to automate processes within a building or within an individual logistics system. Typical applications include logistics automation systems for baggage and freight handling at airports, traffic monitoring (toll systems), retail, parcel distribution and building security (access control). What is meant by the examples listed above is that presence detection in combination with precise measurement of the size and position of an object is required by the respective application. Sensors based on optical measurement methods using lasers, LEDs, 2D cameras or 3D cameras, which detect distances according to the time-of-flight (ToF) principle, can be used for this purpose.

Another area of process automation in the industrial environment is factory/production automation. Applications for this can be found in a wide variety of sectors such as automotive manufacturing, food production, the pharmaceutical industry or in the packaging sector in general. The aim of factory automation is to automate the production of goods using machines, production lines and/or robots, i.e. to run them without human intervention. The sensors used here and the specific requirements in terms of measuring accuracy when detecting the position and size of an object are comparable to those in the previous example of logistics automation.

According to a further embodiment, the measuring sensor has a sleep mode.

The measurement sensor may be configured to be de-energized in sleep mode or to be supplied with power by the second supply unit. The control device of the energy management arrangement can be configured to de-energize the measurement sensor in sleep mode or to supply power to the measurement sensor through the second supply unit in sleep mode.

In other words, the sleep mode can be provided alongside the operating mode in the measurement sensor. The measuring sensor can be completely de-energized in the idle mode or sleep mode or can be supplied by a battery or rechargeable battery unit with little or no energy from light. It may be provided that the measuring sensor is only activated when the light energy is detected or determined and when the energy harvesting arrangement generates the corresponding energy. Furthermore, the control device can be configured to activate or alternate the energy supply for the measurement sensor by the solar harvesting arrangement as the first supply unit in the operating mode or by the second supply unit in the idle mode on an event-driven basis.

A further aspect relates to an energy management arrangement for a measuring system which has a measuring sensor for measuring a filling level, a limit level and/or a pressure. The energy management arrangement has a control device which can be configured to activate an operating mode of the measuring sensor and/or to control the power supply for the measuring sensor.

In addition, the control device is configured to couple with the measuring sensor and activate the operating mode of the measuring sensor on an event-driven basis.

A further aspect relates to the use of an energy management arrangement for a measuring system to save energy when the measuring system is used in a process plant.

A further aspect relates to the use of a measuring system for level, limit level and/or pressure measurement in a container and/or at an open measuring point of a body of water.

Another aspect relates to a method using a measuring system which is configured to measure a filling level, a limit level and/or a pressure. The method comprises the following steps: arranging a measuring sensor with an operating mode within a container and/or at a dark measuring point; providing an energy management arrangement with a control device to control the power supply for the measuring sensor; coupling the control device of the energy management arrangement to the measuring sensor; and activating the operating mode of the measuring sensor in an event-oriented manner and/or generating the electrical energy for operating the measuring sensor in the operating mode and/or supplying the measuring sensor in the operating mode with the generated electrical energy by means of the control device of the energy management arrangement.

According to a further embodiment, the method further comprises the step of setting the measurement sensor into a sleep mode without current or of supplying the measurement sensor in the sleep mode with current by a second supply unit of the energy management arrangement by means of the control device of the energy management arrangement.

A further aspect relates to a computer-readable medium on which a program element is stored which, when executed on a processor of a measuring system, instructs the measuring system to perform the steps of the method according to the present disclosure.

In the following, embodiments of the present disclosure are described with reference to the figures. If the same reference signs are used in the description of the figures, these describe the same or similar elements. The illustrations in the figures are schematic and not to scale.

### BRIEF DESCRIPTION OF THE FIGURES

FIG. 1 shows a schematic representation of a measuring system according to an embodiment.

FIG. 2 shows a schematic representation of a measuring system according to an embodiment.

FIG. 3 shows a schematic representation of an energy management arrangement of a measuring system according to an embodiment.

FIG. 4 shows a schematic representation of a measuring system according to an embodiment.

FIG. 5 shows a flow chart of a process according to an embodiment.

### DETAILED DESCRIPTION OF EMBODIMENTS

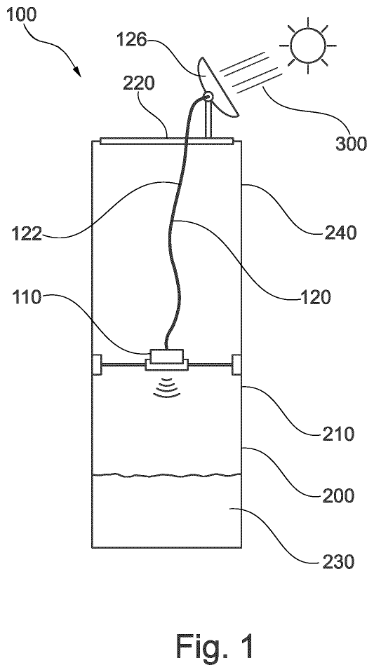

FIG. 1 schematically shows a measuring system 100 which is configured to measure a fill level, a limit level and/or a pressure in a container 200 with a filling material 230. The measuring system 100 has a measuring sensor 110, which has an operating mode, and an energy management arrangement 120.

The energy management arrangement 120 can have a control device and be configured to control the power supply for the measurement sensor 110. In addition, the control device of the energy management arrangement 120 can be coupled to the measurement sensor and can be configured to activate the operating mode of the measurement sensor 110 in an event-oriented manner and/or to generate the electrical energy for operating the measurement sensor 110 in the operating mode and/or to supply the measurement sensor 110 in the operating mode with the generated electrical energy.

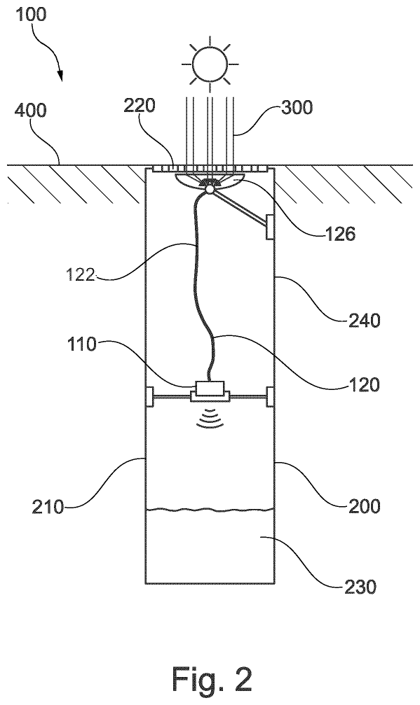

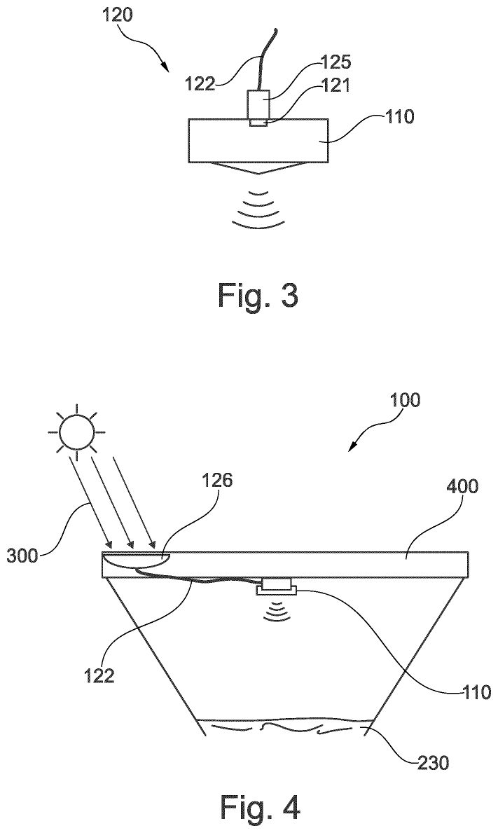

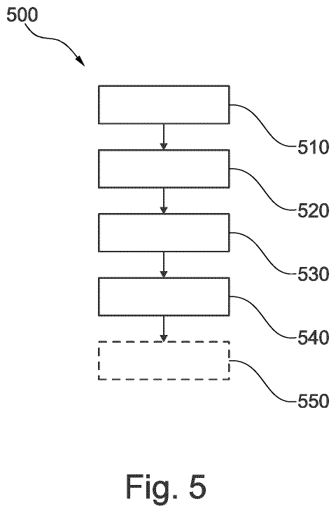

The energy management arrangement 120 may comprise a solar harvesting arrangement as a first supply unit, as shown in FIG. 1, FIG. 2 and FIG. 3. The solar harvesting arrangement may be arranged to supply the measurement sensor 110 with the electrical energy in the operating mode.

The solar harvesting arrangement of the energy management arrangement 120 may comprise a light collecting unit 126, which may be arranged to collect and/or concentrate the light energy. In particular, FIG. 3 shows a structure of the energy management arrangement 120 with the solar harvesting arrangement, which may further comprise an optical fiber 122 and a solar cell 121. In addition, the solar harvesting arrangement of the energy management arrangement 120 can furthermore have a connection 125, which can be configured for retrofittable mounting of the optical waveguide 122 and/or the light collection unit 126 on the measurement sensor 120. The connection 125 can, for example, be arranged directly on the solar cell 121 or between the solar cell 121 and the optical fiber 122.

The solar cell 121 may be arranged to generate or convert the electrical energy from the light energy that may be collected or concentrated by the light collection unit 126. The solar cell 121 may, for example, be arranged on the measurement sensor 110 or integrated into the measurement sensor 110.

As shown in FIG. 1, FIG. 2 and FIG. 4, the optical waveguide 122 may be arranged between the light collection unit 126 and the solar cell 121 in order to be able to guide the light energy from the light collection unit 126 to the solar cell 121.

The light collection unit 126 may include a lens or lens assembly for concentrating light rays, such as the sun. By means of the optical fiber 122, the light gathering unit 126 may be spaced apart or offset from the solar cell 121. The distance between the light-collecting unit 126 and the solar cell 121 may be provided depending on the application. The optical waveguide 122 can therefore be flexible and/or elongated. Alternatively, the optical waveguide 122 may be rigid. For example, the optical waveguide 122 may comprise a fiber optic cable.

FIG. 1 shows that the measurement sensor 110 can be arranged inside the container 200 or inside the housing 210 of the container over the filling material 230, while the lens of the light collecting unit 126 can be arranged outside the container on the container lid 220, irrespective of whether the container lid 220 is transparent or not. The optical fiber 122 may be provided through the container lid 220 or the housing 210 to guide the collected or concentrated light energy from the light collection unit 126 on the outside of the container to the measurement sensor 110 inside the container 200. The measuring sensor 110 can therefore be arranged to measure the filling level, the limit level and/or the pressure without spatial limitation and without taking into account the light beam.

Furthermore, the light-collecting unit 126 can be designed to be movable, so that the light-collecting unit can be flexibly aligned. The light collection unit 126 can be designed to be movable so that it can automatically track the sun. Thus, the light energy can be aligned by the movement of the light collection unit 126 so that the maximum light energy from the light source or the sun can be efficiently collected and concentrated. The light collecting unit 126 can be operated completely without a power supply or with a battery or an accumulator.

Alternatively, compared to FIG. 1, the light collection unit 126 in FIG. 2 may be arranged within the housing 210 of the container 200 or the lattice shaft, if, for example, the container lid 220 may be transparent or at least partially transparent. For example, the container lid 220 may be a lattice manhole cover that may be arranged at an open location 400, such as a road, or may even be built into a road. The light collection unit 126 may be provided below the container lid 220 at the open location 400 of the road such that the light energy of the light beam 300 from the sun as a light source may be collected by the light collection unit 126 through the container lid 220. In contrast, the measurement sensor 110 may be provided at a dark measurement location within the container housing 210.

For example, the lens of the light-collecting unit 126 can focus the light even when the incidence of light is at an angle, so that there can be significant advantages compared to a solar panel without a lens. Possible soiling or partial shading can also hardly have a negative effect on power generation.

FIG. 4 further shows that the measurement system 300 may alternatively be used at an open location 400, such as a bridge, to measure the level and/or the limit level of a body of water. The light collecting unit 126 may, for example, be arranged on the upper side of the bridge or be formed in an integrated manner in order to receive, collect and/or concentrate the light energy of the light beam 300. The measurement sensor 110, on the other hand, may be arranged at a dark location below the bridge 400 over the body of water 230. The light collecting unit 126 and the measuring sensor 110, which may be arranged remotely or offset from each other, may be connected via the optical fiber 122.

Furthermore, the energy management arrangement 120 can be configured by means of the control device, which can be coupled to the measurement sensor 110 of the measurement system 100, to activate the operating mode of the measurement sensor 110 in an event-oriented manner, to generate the electrical energy for operating the measurement sensor 110 in the operating mode and/or to supply the measurement sensor 110 in the operating mode with the generated electrical energy. In an event-oriented manner, activation by means of the control device of the energy management arrangement 120 can take place on the basis of the presence or detection of the light beam 300, for example at sunrise, a predetermined light intensity of the light beam and/or a predetermined angle of incidence of the light beam.

It can also be provided that the control device of the energy management arrangement 120 can be configured to activate the operating mode of the measurement sensor 110 with a predefined time interval. For example, the energy management arrangement 120 may further comprise a second supply unit, which may be configured to supply the measuring sensor 110 with the power. The second supply unit can be a battery or an accumulator.

In addition to the operating mode, the measuring sensor 110 can also have a sleep mode. The measurement sensor 110 can be configured to be de-energized in the idle mode or to be supplied with the second supply unit. Accordingly, the control device of the energy management arrangement 120 can be configured to de-energize the measurement sensor 110 in the idle mode or to supply power to the measurement sensor 110 through the second supply unit in the idle mode. As a result, the control device can be configured to activate or alternate the energy supply for the measurement sensor 110 by the solar harvesting arrangement as the first supply unit in the operating mode or by the second supply unit in the idle mode in an event-oriented manner.

FIG. 3 shows a flow diagram of a method 500 using a measuring system 100, which can be configured to measure a filling level, a limit level and/or a pressure. In step 510, a measuring sensor 110, which may have an operating mode and/or a rest mode, is arranged inside a container and/or at a dark measuring point.

In step 520, a power management arrangement 120 is provided with a control device for the measurement system 100 to control the power supply for the measurement sensor 110.

In step 530, the control device of the energy management arrangement 120 is coupled to the measurement sensor 110.

In step 540, the operating mode of the measurement sensor 110 is activated in an event-oriented manner, the electrical energy for operating the measurement sensor 110 in the operating mode is generated and/or the measurement sensor 110 in the operating mode is supplied with the generated electrical energy by means of the control device of the energy management arrangement 120.

A further step 550 may be provided, in which the measurement sensor 110 can be set to idle mode without current or the measurement sensor 110 can be supplied with current in idle mode by a second supply unit of the energy management arrangement 120 by means of the control device.

In addition, it should be noted that “comprising” and “having” do not exclude other elements or steps and the indefinite articles “a” or “an” do not exclude a plurality. It should also be noted that features or steps described with reference to one of the above embodiments may also be used in combination with other features or steps of other embodiments described above. Reference signs in the claims are not to be regarded as limitations.

1. A measuring system configured to measure at least one of a filling level, a limit level or a pressure, comprising:
a measurement sensor having an operation mode; and
energy management circuitry having a control device and being configured to control a power supply for the measuring sensor,
wherein the control device of the energy management circuitry is coupled to the measurement sensor and is configured to:
activate the operating mode of the measurement sensor in an event-oriented manner, and/or
generate electrical energy for operating the measurement sensor in the operating mode, and/or
supply the measurement sensor with the generated electrical energy in the operating mode.

2. The measuring system according to claim 1,
wherein the energy management circuitry further includes solar harvesting circuitry as a first supply circuit, and
wherein the solar harvesting circuitry is further configured to supply the measurement sensor with the electrical energy in the operating mode.

3. The measuring system according to claim 1,
wherein solar harvesting circuitry of the energy management circuitry further includes a light collecting circuit arranged to collect and/or concentrate light energy, an optical waveguide and a solar cell arranged to generate the electrical energy from the light energy, and
wherein the optical waveguide is arranged between the light collecting circuit and the solar cell and is configured to guide the light energy from the light collecting circuit to the solar cell.

4. The measuring system according to claim 3,
wherein the light collecting circuit is arranged at a distance from the solar cell.

5. The measuring system according to claim 3,
wherein the light collecting circuit includes a lens.

6. The measuring system according to claim 3,
wherein the light collecting circuit is designed to be movable so that the light collecting circuit can be flexibly aligned.

7. The measuring system according to claim 3,
wherein the solar harvesting circuitry of the energy management circuitry further comprises a connection which is arranged for retrofittable mounting of the optical waveguide and/or the light collecting circuit to the measuring sensor.

8. The measuring system according to claim 3,
wherein the solar cell is arranged at the measuring sensor, or
wherein the solar cell is integrated in the measuring sensor.

9. The measuring system according to claim 3,
wherein the optical waveguide is flexible and/or elongated.

10. The measuring system according to claim 1,
wherein the measuring sensor is arranged inside a container and/or at a dark measuring point.

11. The measuring system according to claim 1,
wherein the control device of the energy management circuitry is configured to activate the operating mode of the measurement sensor at a predefined time interval.

12. The measuring system according to claim 1,
wherein the energy management circuitry further includes a second supply circuit which is configured to supply the measuring sensor with current.

13. The measuring system according to claim 12,
wherein the second supply circuit is a battery or an accumulator.

14. The measuring system according to claim 12,
wherein the measuring sensor has a sleep mode,
wherein the measuring sensor is further configured to be de-energized in an idle mode or to be supplied with the second supply circuit, and
wherein the control device of the energy management circuitry is configured to de-energize the measurement sensor in the sleep mode or to supply power to the measurement sensor through the second supply circuit in the sleep mode.

15. Energy management circuitry for a measuring system, comprising:
a measuring sensor configured to measure at least one of a level, a limit level or a pressure; and
a control device configured to activate an operating mode of the measuring sensor and/or to control a power supply for the measuring sensor,
wherein the control device is further configured to couple with the measuring sensor and to activate the operating mode of the measuring sensor in an event-oriented manner.

16. A method for measuring a filling level, a limit level and/or a pressure, by a measuring system, comprising:
arranging a measuring sensor with an operating mode inside a container and/or at a dark measuring point;
providing energy management circuitry with a control device to control a power supply for the measuring sensor;
coupling the control device of the energy management circuitry to the measurement sensor; and
event-oriented activating the operating mode of the measurement sensor and/or generating the electrical energy for operating the measurement sensor in the operating mode and/or supplying the measurement sensor in the operating mode with the generated electrical energy by the control device of the energy management circuitry.

17. The method according to claim 16, further comprising:
switching the measurement sensor to a sleep mode without current or supplying the measurement sensor in the sleep mode with current by a second supply circuit of the energy management circuitry by the control device of the energy management circuitry.

18. A non-transitory computer-readable medium on which is stored a program element which, when executed on a processor of a measuring system instructs the measuring system to implement the method according to claim 16.

19. The measuring system according to claim 2,
wherein solar harvesting circuitry of the energy management circuitry further includes a light collecting circuit arranged to collect and/or concentrate light energy, an optical waveguide and a solar cell arranged to generate the electrical energy from the light energy, and
wherein the optical waveguide is arranged between the light collecting circuit and the solar cell and is configured to guide the light energy from the light collecting circuit to the solar cell.

20. The measuring system according to claim 4,
wherein the light collecting circuit includes a lens.
